(19) United States
(12) Patent Application Publication
(10) Pub. No.: US 2010/0034391 A1
(43) Pub. Date: Feb. 11, 2010

(54) CRYPTOGRAPHIC-KEY MANAGEMENT SYSTEM, EXTERNAL DEVICE, AND CRYPTOGRAPHIC-KEY MANAGEMENT PROGRAM

(75) Inventors: Yoshikazu YAMAGISHI, Tokyo (JP); Yuuichi Koubata, Utsunomiya-city (JP); Yoshiyuki Takagi, Nagoya-city (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Buffalo Inc., Nagoya (JP)

(21) Appl. No.: 12/535,292

(22) Filed: Aug. 4, 2009

(30) Foreign Application Priority Data
Aug. 11, 2008 (JP) 2008-207360

(51) Int. Cl. H04L 9/08; G06F 12/14

(52) U.S. Cl. 380/278; 713/193

(57) ABSTRACT

An external device (10) includes a memory (11) configured to store an external-device identifier that is an identifier of the external device. The memory includes a storage area (11a) to store a cryptographic key for copyrighted data. The cryptographic key is not stored in the storage area in the initial state, and the cryptographic key corresponding to the external-device identifier is written to the storage area by a terminal (20).

### CROSS REFERENCE TO RELATED APPLICATION

This application is based upon and claims the benefit of priority from the prior Japanese Patent Applications No. 2008-207360 filed on Aug. 11, 2008; the entire contents of which are incorporated herein by reference.

### BACKGROUND OF THE INVENTION

1. Field of the Invention

The present invention relates to a cryptographic-key management system, an external device, and a cryptographic-key management program, for managing a cryptographic key for copyrighted data.

2. Description of the Related Art

It is a common practice to connect an external device such as a TV tuner to a terminal such as a personal computer. In addition, various techniques have already been known for connecting a terminal to a network such as a Wide Area Network (WAN) or a Local Area Network (LAN).

In the meanwhile, techniques to protect the copyright of digital data (e.g., DRM: Digital Right Management) attract much attention (see, for example, Japanese Patent Application Publication No. 2006-157184).

For example, a technique known as Content Protection for Recordable Media (CPRM) is proposed as a countermeasure against unauthorized copying of digital data whose copyright is protected (hereafter, referred to as “copyrighted data”). In addition, a technique known as Digital Transmission Content Protection over Internet Protocol (DTCP-IP) is proposed as a countermeasure against unauthorized distribution of copyrighted data through a network.

In CPRM, a terminal decrypts copyrighted data using a cryptographic key (CPRM key) that is assigned to an external device. It is a common practice to store the CPRM key in the terminal.

In DTCP-IP, a terminal encrypts copyrighted data using a cryptographic key (DTCP key) that is assigned to an external device. It is a common practice to store the DTCP key in the terminal. If the terminal has no DTCP key stored therein, the transmission of copyrighted data is restricted.

Incidentally, suppose a case where a user owns plural terminals and a single external device. In this case, the single external device is possibly connected to each of the plural terminals. To put it differently, the single external device is shared by the plural terminals.

However, only a single cryptographic key is generally assigned to each external device. Additionally, the cryptographic key such as a CPRM key or a DTCP key is stored in the terminal.

Accordingly, the cryptographic key, such as a CPRM key or a DTCP key is stored in only one of the plural terminals. In other words, only one of the terminals is permitted to copy, reproduce, and transmit a particular copyrighted data.

In the case of sharing a single external device with plural terminals as described above, the copying, reproducing, and transmitting of a particular copyrighted data is limited to only one of the plural terminals. Such a limitation reduces the convenience of the user.

### SUMMARY OF THE INVENTION

The present invention has been made to solve the above-mentioned problem, and an object thereof is to provide a cryptographic-key management system, an external device, and a cryptographic-key management program that are capable of improving the convenience of the user.

A cryptographic-key management according to a first aspect of the present invention comprises: an external device (external device 10) configured to store an external-device identifier that is an identifier for the external device; a terminal (terminal 20) configured to be connected to the external device; and a server (server 30) configured to associate the external-device identifier and a cryptographic key of copyrighted data with each other, and to store the external-device identifier and the cryptographic key thus associated with each other. The external device includes a memory (memory 11) having a storage area (storage area 11a) in which the cryptographic key is stored. The terminal includes: an acquisition-request transmitter (transmitter 21) configured to transmit a cryptographic-key acquisition request including the external-device identifier to the server; a receiver (receiver 22) configured to receive the cryptographic key from the server, the cryptographic key being associated with the external-device identifier included in the cryptographic-key acquisition request; a writer (writer 23) configured to write the cryptographic key received from the server to the storage area; a reader (reader 24) configured to read the cryptographic key from the storage area; and a data processor (controller 25) configured to process the copyrighted data using the cryptographic key read from the storage area. According to the aspect, the external device includes the memory that includes the storage area to store the cryptographic key. The terminal stores the cryptographic key that has been received from the server in the storage area.

As described above, the storage area provided in the external device stores the cryptographic key. Accordingly, even when plural terminals share a single external device, just connecting the external device to the terminals allows any one of the terminals to use the cryptographic key and thus to process the copyrighted data. Consequently, the convenience for the user is improved.

In the first aspect, the server includes: a cryptographic-key transmitter (transmitter 32) configured to transmit the cryptographic key to the terminal, the cryptographic key being associated with the external-device identifier included in the cryptographic-key acquisition request; and a manager (manager 33) configured to manage whether or not the cryptographic key has been transmitted to the terminal. If the cryptographic-key transmitter has not transmitted the cryptographic key yet by the time of receiving the cryptographic-key acquisition request, the cryptographic-key transmitter transmits the cryptographic key associated with the external-device identifier to the terminal. If the cryptographic-key transmitter has already transmitted the cryptographic key by the time of receiving the cryptographic-key acquisition request, the cryptographic-key transmitter cancels transmitting the cryptographic key associated with the external-device identifier.

In the first aspect, the terminal further includes a controller to determine whether or not the cryptographic key is stored in the storage area provided in the external device before the transmission of the cryptographic-key acquisition request. If the cryptographic key is not stored in the storage area, the acquisition-request transmitter transmits the cryptographic-key acquisition request.

In the first aspect, the cryptographic key is not stored in the storage area provided in the external device in the initial state, and the cryptographic key corresponding to the external-device identifier is written to the storage area by the terminal.

In the first aspect, the external device is capable of being disconnected from the terminal, and is capable of being connected to a different terminal that is different from the terminal. The different terminal reads the cryptographic key written to the storage area provided in the external device, and uses the read cryptographic key to process copyrighted data.

An external device according to a second aspect of the present invention is connected to a terminal, and comprises: a memory configured to store an external-device identifier that is an identifier of the external device. The memory includes a storage area to store a cryptographic key for copyrighted data. The cryptographic key is not stored in the storage area in the initial state, and the cryptographic key corresponding to the external-device identifier is written to the storage area by the terminal.

A cryptographic-key management program according to a third aspect of the present invention manages a cryptographic key for copyrighted data by using a computer connected to an external device storing an external-device identifier that is an identifier for the external device. The cryptographic-key management program causing the computer to execute the steps of: transmitting a cryptographic-key acquisition request including the external-device identifier to a server; receiving the cryptographic key from the server, the cryptographic key corresponding to the external-device identifier included in the cryptographic-key acquisition request; and writing the cryptographic key received from the server to a storage area provided in the external device.

In the third aspect, the cryptographic-key management program causes the computer to further execute the steps of: determining whether or not the cryptographic key is stored in the storage area provided in the external device, before the step of transmitting the cryptographic-key acquisition request; and transmitting the cryptographic-key acquisition request if the cryptographic key is not stored in the storage area.

According to the present invention, it is possible to provide a cryptographic-key management system, an external device, and a cryptographic-key management program that are capable of improving the convenience for the user.

### BRIEF DESCRIPTION OF THE DRAWINGS

FIG. 1 is a diagram illustrating a cryptographic-key management system according to a first embodiment.

FIG. 2 is a block diagram illustrating an external device 10 according to the first embodiment.

FIG. 3 is a block diagram illustrating a terminal 20 according to the first embodiment.

FIG. 4 is a block diagram illustrating a server 30 according to the first embodiment.

FIG. 5 is a diagram illustrating a table according to the first embodiment.

FIG. 6 is a sequence diagram illustrating the outlined operation of the cryptographic-key management system according to the first embodiment.

FIG. 7 is a flowchart illustrating the operation of the terminal 20 according to the first embodiment.

FIG. 8 is a flowchart illustrating the operation of the terminal 20 according to the first embodiment.

### DESCRIPTION OF THE EMBODIMENTS

A cryptographic-key management system according to some embodiments of the present invention will be described below by referring to the drawings. In the drawings, identical or similar portions are denoted by identical or similar reference numerals.

It should be noted that the drawings are all schematic and that proportions and the like of dimensions are different from actual ones. Thus, specific dimensions and the like should be determined with the description below taken into consideration. Additionally, these drawings include portions where relations or proportions of dimensions are different therebetween.

### First Embodiment

### Configuration of Cryptographic-Key Management System

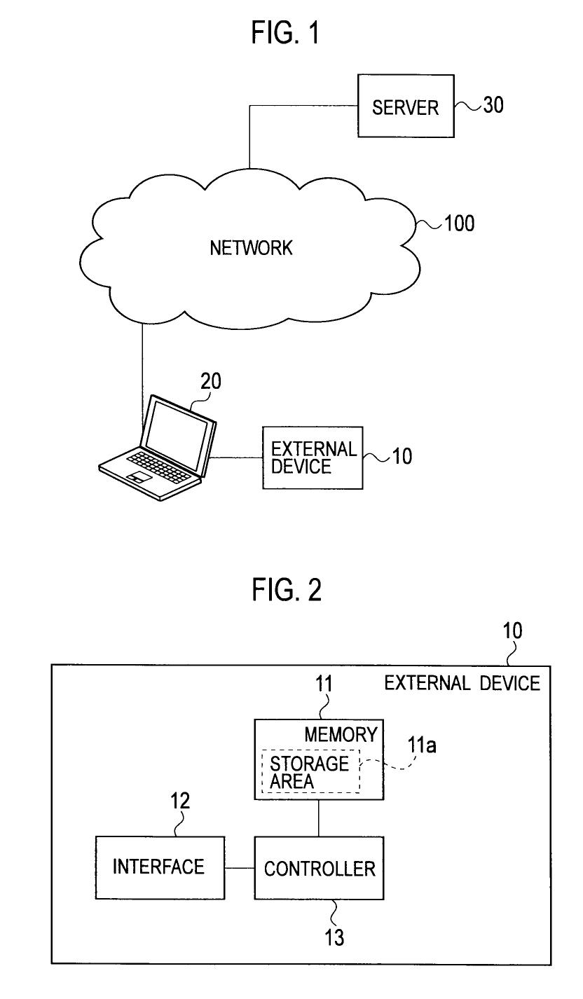

A cryptographic-key management system according to a first embodiment will be described below by referring to the drawings. FIG. 1 is a drawing illustrating a cryptographic-key management system according to the first embodiment.

The cryptographic-key management system includes an external device 10, a terminal 20, a server 30, and a network 100.

The external device 10 is a device connected to the terminal 20. Some examples of the external device 10 are devices such as a TV tuner and a network interface. Some examples of the network interface are LAN card and a wireless LAN adaptor. The external device 10 acquires, for example, digital data whose copyright is protected (hereafter, referred to as “copyrighted data”).

The terminal 20 is a terminal connected to the external device 10. An example of the terminal 20 is a personal computer. The terminal 20 controls the external device 10 that is connected thereto. The terminal 20 processes the copyrighted data that has been stored therein. Some examples of the processing of the copyrighted data are: writing the copyrighted data to a medium such as a DVD; and transmitting the copyrighted data to another terminal via a network such as a LAN.

The server 30 manages a cryptographic key that is used for protecting the copyrighted data. Specifically, the server 30 assigns a cryptographic key to the external device 10. The server 30 preferably assigns a cryptographic key to each external device 10. The server 30, however, is allowed to assign plural cryptographic keys to each external device 10.

An example of the cryptographic key to protect copyrighted data is a CPRM key that is used in CPRM (Content Protection for Recordable Media) to prohibit unauthorized copying of copyrighted data. The CPRM key is used for decrypting copyrighted data.

Another example of the cryptographic key to protect copyrighted data is a DTCP key that is used in DTCP-IP (Digital Transmission Content Protection over Internet Protocol) to prohibit unauthorized distribution of copyrighted data. The DTCP key is used for encrypting copyrighted data.

Some examples of the network 100 are networks such as the WAN and the LAN. The network 100 may be a wireless network, or alternatively, may be a wired network.

### (Configuration of External Device)

The external device according to the first embodiment will be described below by referring to the drawings. FIG. 2 is a block diagram illustrating the external device 10 according to the first embodiment.

As FIG. 2 shows, the external device 10 includes a memory 11, an interface 12, and a controller 13.

The memory 11 stores an external-device identifier serving as an identifier for the device that the memory 11 belongs to. The memory 11 includes a storage area 11a in which a cryptographic key to be used for protecting copyrighted data is stored.

In the initial state, the storage area 11a stores no cryptographic key. The terminal 20 writes, to the storage area 11a, a cryptographic key corresponding to the external-device identifier. Note that the “initial state” mentioned above refers to a state of the storage area 11a, for example, at the time of shipment.

The interface 12 serves as an interface between the external device 10 and the terminal 20. Some examples of the interface 12 are a USB interface, and a parallel interface.

The controller 13 controls the external device 10. For example, the controller 13 acquires a cryptographic key from the terminal 20 in response to a request from the terminal 20, and then stores the acquired cryptographic key in the storage area 11a. The controller 13 outputs the cryptographic key stored in the storage area 11a to the terminal 20 in response to a request from the terminal 20.

### (Configuration of Terminal)

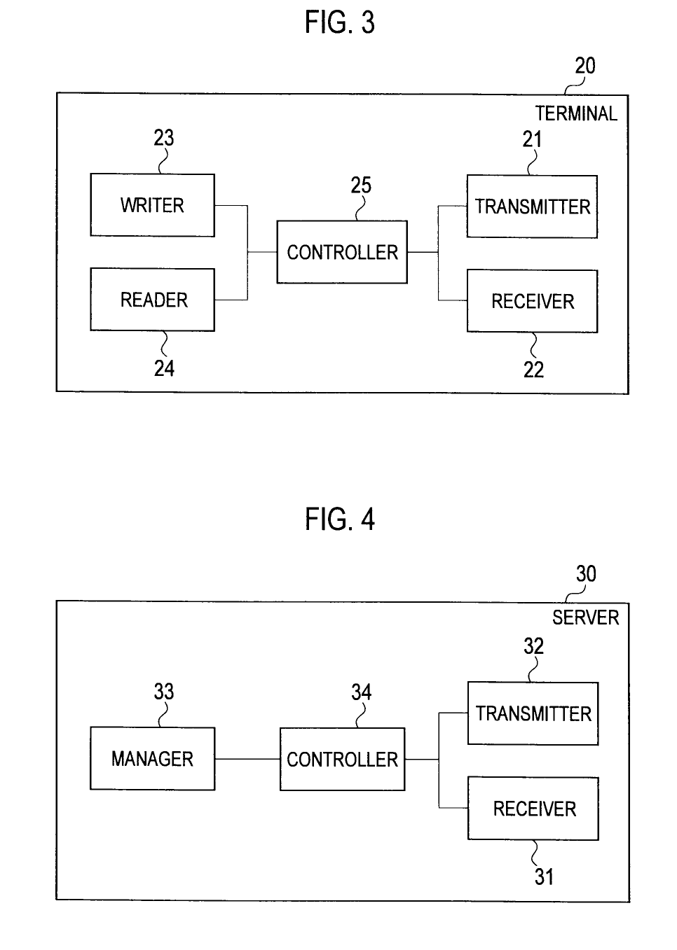

The terminal according to the first embodiment will be described below by referring to the drawings. FIG. 3 is a block diagram illustrating the terminal 20 according to the first embodiment.

As FIG. 3 shows, the terminal 20 includes a transmitter 21, a receiver 22, a writer 23, a reader 24, and a controller 25.

The transmitter 21 transmits various kinds of information to the server 30 via the network 100. Specifically, the transmitter 21 transmits, to the server 30, a cryptographic-key acquisition request including the external-device identifier of the external device 10.

Note that the external-device identifier of the external device 10 may be read from the external device 10. Alternatively, the user may use an input device such as a keyboard to input the external-device identifier of the external device 10.

The receiver 22 receives various kinds of information from the server 30 via the network 100. Specifically, the receiver 22 receives the cryptographic key which corresponds to the external-device identifier included in the cryptographic-key acquisition request.

The writer 23 instructs the external device 10 to write various kinds of information. Specifically, the writer 23 instructs the external device 10 to write, to the storage area 11a, the cryptographic key received from the server 30. To put it differently, the writer 23 writes, to the storage area 11a, the cryptographic key received from the server 30.

The reader 24 instructs the external device 10 to read various kinds of information. Specifically, the reader 24 instructs the external device 10 to read the cryptographic key from the storage area 11a. To put it differently, the reader 24 reads the cryptographic key from the storage area 11a.

The controller 25 controls the terminal 20. For example, the controller 25 instructs the reader 24 to read the cryptographic key in response to a data-processing request that requests the processing of the copyrighted data. On condition that the cryptographic key has been read from the storage area 11a provided in the external device 10, the controller 25 processes the copyrighted data. Note that the user inputs, using an input device such as a keyboard, the data-processing request that requests the processing of the copyrighted data.

For example, if the data-processing request requests the decrypting and the writing of the copyrighted data, the controller 25 instructs the reader 24 to read the CPRM key. The controller 25 uses the CPRM key read from the storage area 11a to decrypt the copyrighted data. The controller 25 writes the decrypted copyrighted data to a medium such as a DVD.

For example, if the data-processing request requests the transmitting of the copyrighted data, the controller 25 instructs the reader 24 to read the DTCP key. The controller 25 uses the DTCP key read from the storage area 11a to encrypt the copyrighted data. Then the controller 25 transmits the encrypted copyrighted data to the network 100.

If the controller 25 fails to read the cryptographic key from the storage area 11a provided in the external device 10, the controller 25 instructs the transmitter 21 to transmit the cryptographic-key acquisition request including the external-device identifier of the external device 10. To put it differently, if the storage area 11a provided in the external device 10 stores no cryptographic key, the controller 25 instructs the transmitter 21 to transmit the cryptographic-key acquisition request.

For example, if the data-processing request requests the decrypting and the writing of the copyrighted data, the controller 25 instructs the transmitter 21 to transmit a CPRM-key acquisition request.

For example, if the data-processing request requests the transmitting of the copyrighted data, the controller 25 instructs the transmitter 21 to transmit a DTCP-key acquisition request.

### (Configuration of Server)

The server according to the first embodiment will be described below by referring to the drawings. FIG. 4 is a block diagram illustrating the server 30 according to the first embodiment server 30.

As FIG. 4 shows, the server 30 includes a receiver 31, a transmitter 32, a manager 33, and a controller 34.

The receiver 31 receives various kinds of information from the terminal 20 via the network 100. Specifically, the receiver 31 receives, from the terminal 20, the cryptographic-key acquisition request including the external-device identifier of the external device 10.

The transmitter 32 transmits various kinds of information to the terminal 20 via the network 100. Specifically, the transmitter 32 transmits, to the terminal 20, the cryptographic key corresponding to the external-device identifier included in the cryptographic-key acquisition request.

The manager 33 associates the external-device identifier and the cryptographic key with each other and manages them. In addition, the manager 33 manages whether the cryptographic key has already been transmitted or not yet.

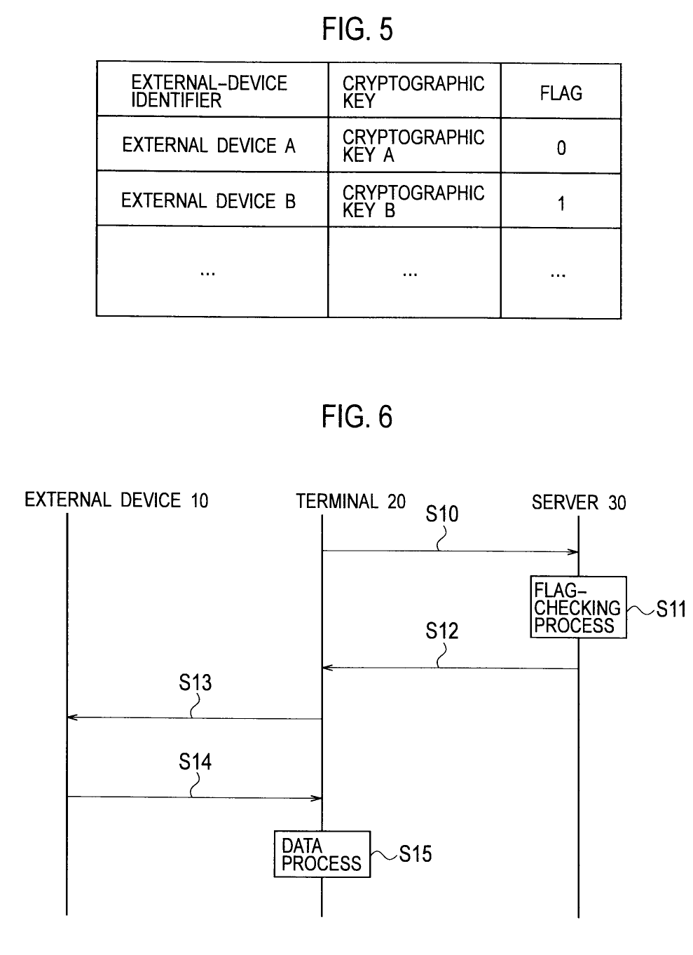

For example, the manager 33 manages a table shown in FIG. 5. As FIG. 5 shows, the manager 33 manages the table in which external-device identifiers, the cryptographic keys, and flags are associated with one another. The flags mentioned here are flags to manage whether their respective cryptographic keys have already been transmitted or not yet. If the cryptographic key has not been transmitted yet, a value “0” is set for the flag. If the cryptographic key has already been transmitted, a value “1” is set for the flag.

In the example shown in FIG. 5, a value “0” is set for the flag of the cryptographic key A corresponding to the external device A, which means that the cryptographic key A has not been transmitted yet. A value “1” is set for the flag of the cryptographic key B corresponding to the external device B, which means that the cryptographic key B has already been transmitted.

The controller 34 manages the server 30. For example, when the controller 34 receives the cryptographic-key acquisition request, the controller 34 checks the flag corresponding to the external-device identifier included in the cryptographic-key acquisition request. If a value “0” is set for the flag, the controller 34 instructs the transmitter 32 to transmit the cryptographic key. To put it differently, if the cryptographic key has not been transmitted yet, the controller 34 instructs the transmitter 32 to transmit the cryptographic key corresponding to the external-device identifier included in the cryptographic-key acquisition request. Conversely, if a value “1” is set for the flag, the controller 34 stops transmitting the cryptographic key. To put it differently, if the cryptographic key has already been transmitted, the controller 34 stops transmitting the cryptographic key corresponding to the external-device identifier included in the cryptographic-key acquisition request. The controller 34 may instruct the transmitter 32 to transmit an error message signifying that the cryptographic key has already been transmitted.

### (Outlined Operation of Cryptographic-Key Management System)

The outlined operation of the cryptographic-key management system according to the first embodiment will be described below by referring to the drawings. FIG. 6 is a sequence diagram illustrating the outlined operation of the cryptographic-key management system according to the first embodiment.

As FIG. 6 shows, the terminal 20 transmits, to the server 30, the cryptographic-key acquisition request including the external-device identifier at step S10.

At step S11, the server 30 checks the flag corresponding to the external-device identifier. The subsequent description is based on the assumption that a value “0” is set for the flag.

Note that if a value “1” is set for the flag, the server 30 does not transmit the cryptographic key corresponding to the external-device identifier. In this case, the server 30 may transmit an error message signifying that the cryptographic key has already been transmitted.

At step S12, the server 30 transmits, to the terminal 20, the cryptographic key corresponding to the external-device identifier.

At step S13, the terminal 20 writes the cryptographic key received from the server 30 to the storage area 11a provided in the external device 10.

At step S14, the terminal 20 reads the cryptographic key from the storage area 11a provided in the external device 10.

At step S15, the terminal 20 uses the cryptographic key read from the storage area 11a to process the copyrighted data. For example, if the cryptographic key is a CPRM key, the terminal 20 uses the CPRM key to decrypt the copyrighted data. If the cryptographic key is a DTCP key, the terminal 20 encrypts the copyrighted data and then transmits the encrypted copyrighted data to the network 100.

Note that the processes executed from step S10 to step S13 are the processes to write the cryptographic key to the storage area 11a provided in the external device 10. The processes executed at step S14 and step S15 are processes to process the copyrighted data. Accordingly, the process executed at step S14 does not have to be executed following the process executed at step S13.

### (Operation of Terminal)

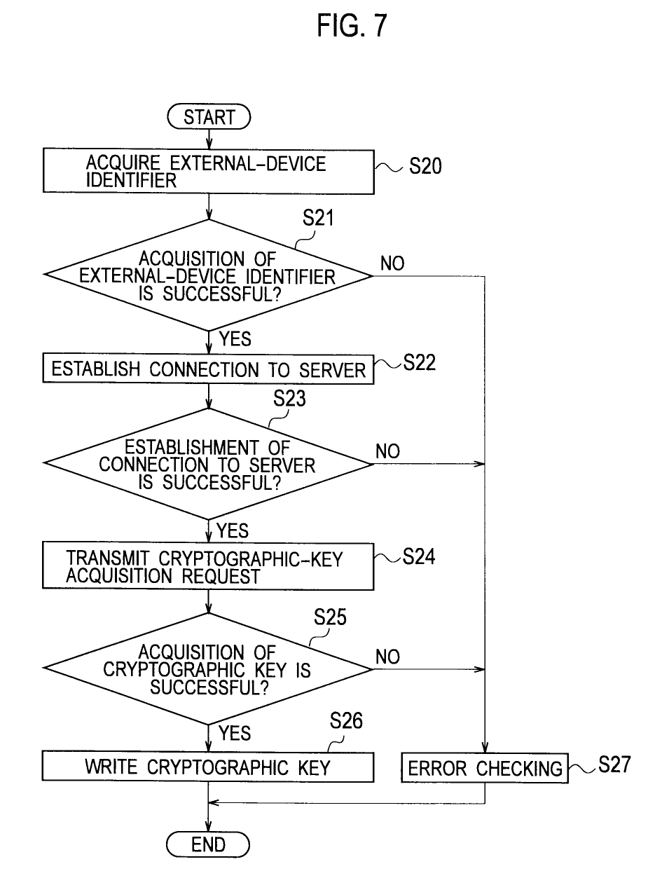

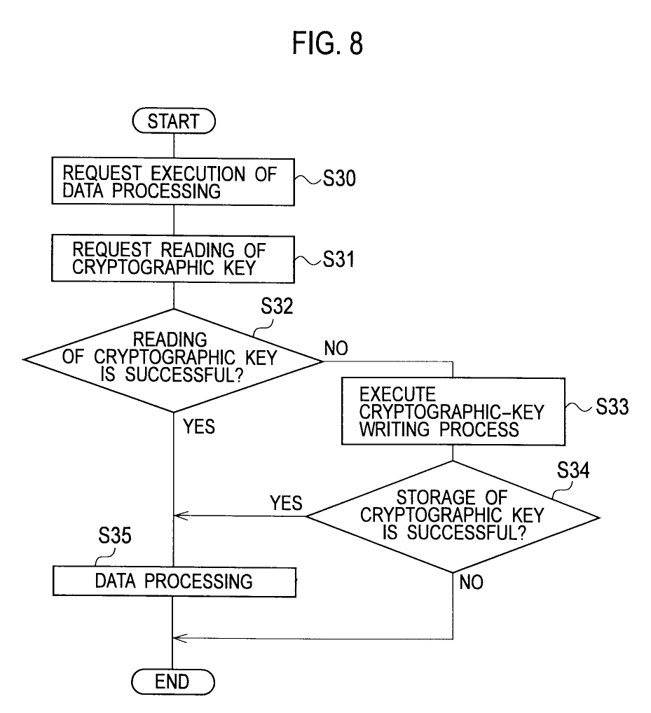

The Operation of the terminal according to the first embodiment will be described below by referring to the drawings. FIG. 7 and FIG. 8 are flowcharts illustrating the operation of the terminal 20 according to the first embodiment.

Firstly, the processes to write the cryptographic key to the storage area 11a provided in the external device 10 will be described by referring to FIG. 7.

As FIG. 7 shows, at step S20, the terminal 20 acquires the external-device identifier of the external device 10. For example, the terminal 20 may read the external-device identifier from the external device 10. Alternatively, the terminal 20 may acquire external-device identifier that the user inputs using an input device such as a keyboard.

At step S21, the terminal 20 determines whether the external-device identifier has been successfully acquired or not. If the external-device identifier has been successfully acquired, the terminal 20 proceeds to execute the process of step S22. If the external-device identifier has not been successfully acquired, the terminal 20 proceeds to execute the process of step S27.

At step S22, the terminal 20 establishes the connection to the server 30.

At step S23, the terminal 20 determines whether the connection to the server 30 has been successfully established or not. If the connection to the server 30 has been successfully established, the terminal 20 proceeds to execute the process of step S24. If the connection to the server 30 has not been successfully established, the terminal 20 proceeds to execute the process of step S27.

At step S24, the terminal 20 transmits, to the server 30, the cryptographic-key acquisition request including the external-device identifier acquired at step S20.

At step S25, the terminal 20 determines whether the cryptographic key has been successfully acquired from the server 30 or not. If the cryptographic key has been successfully acquired, the terminal 20 proceeds to execute the process of step S26. If the cryptographic key has not been successfully acquired, the terminal 20 proceeds to execute the process of step S27.

There are various occasions on which the cryptographic key cannot be successfully acquired. For example, the cryptographic key may have already been transmitted. Alternatively, the external-device identifier may be an unauthentic identifier.

At step S26, the terminal 20 stores, in the storage area 11a provided in the external device 10, the cryptographic key received from the server 30.

At step S27, the terminal 20 executes an error-checking process. There are various kinds of errors to occur. Some examples of the errors are: (1) unsuccessful acquisition of the external-device identifier; (2) unsuccessful establishment of the connection to the server 30; and (3) unsuccessful acquisition of the cryptographic key.

Secondly, the processes to process the copyrighted data will be described by referring to FIG. 8.

At step S30, the terminal 20 acquires the data-processing request that requests the processing of the copyrighted data. The user inputs the data-processing request using an input device such as a keyboard.

At step S31, the terminal 20 requests the external device 10 to read the cryptographic key.

At step S32, the terminal 20 determines whether the cryptographic key has been successfully read from the external device 10 or not. To put it differently, the terminal 20 determines whether or not the cryptographic key is stored in the storage area 11a provided in the external device 10. If the cryptographic key has been successfully read, the terminal 20 proceeds to execute the process of step S35. If the cryptographic key has not been successfully read, the terminal 20 proceeds to execute the process of step S33.

At step S33, the terminal 20 executes a cryptographic-key writing process. Details of the cryptographic-key writing process are illustrated in FIG. 7. Specifically, at step S33, the terminal 20 tries to acquire the cryptographic key from the server 30. If the cryptographic key has been successfully acquired from the server 30, the terminal 20 proceeds to store the acquired cryptographic key in the storage area 11a provided in the external device 10.

At step S34, the terminal 20 determines whether the cryptographic key has been successfully stored or not. If the cryptographic key has been successfully stored, the terminal 20 proceeds to execute the process of step S35. Note that the terminal 20 may read the cryptographic key from the external device 10 again before the terminal 20 proceeds to execute the process of step S35.

If the cryptographic key has not been successfully stored, the terminal 20 terminates the series of processes. In this case, the terminal 20 may notify, the user, by means of an error message, of the fact that the processing of the copyrighted data is impossible.

At step S35, the terminal 20 uses the cryptographic key read from the storage area 11a to process the copyrighted data. Note that, if the cryptographic key has been acquired at step S33 from the server 30 and the acquired cryptographic key has been written to the storage area 11a, the terminal 20 does not have to read the cryptographic key from the storage area 11a. To put it differently, the terminal 20 may use the cryptographic key acquired from the server 30 to process the copyrighted data.

### ADVANTAGEOUS EFFECTS

According to the first embodiment, the external device 10 includes the memory 11 having the storage area 11a to store the cryptographic key. The terminal 20 stores, in the storage area 11a, the cryptographic key received from the server 30.

In this way, the cryptographic key is stored in the storage area 11a provided in the external device 10. Accordingly, even if plural terminals 20 share a single external device 10, just connecting the external device 10, in which the cryptographic key is stored, to the terminals 20 allows any one of the terminals 20 to use the cryptographic key to process the copyrighted data. Consequently, the convenience for the user can be improved.

In addition, just connecting the external device 10, in which the cryptographic key is stored, to the terminal 20 allows even the terminal 20 having no connection to the server 30 to use the cryptographic key so as to process the copyrighted data. Consequently, the convenience for the user can be improved.

### Other Embodiments

Although the invention has been described by way of the above-described embodiment, those descriptions and drawings that form parts of this disclosure should never be understood as limitations on the invention. Those skilled in the art may conceive of various alternative embodiments, examples, and techniques to carry out the invention.

For example, a program for causing a computer to execute the operation of the terminal 20 (i.e., the series of processes illustrated in FIG. 7 and FIG. 8) may be provided. In addition, a storage medium having such a program stored therein may be provided. An example of the storage medium having the program stored therein is a CD-ROM provided together with the external device 10.

What is claimed is:

1. A cryptographic-key management system comprising:
an external device configured to store an external-device identifier that is an identifier for the external device;
a terminal configured to be connected to the external device; and
a server configured to associate the external-device identifier and a cryptographic key of copyrighted data with each other, and to store the external-device identifier and the cryptographic key thus associated with each other, wherein
the external device includes a memory having a storage area in which the cryptographic key is stored,
the terminal includes:
an acquisition-request transmitter configured to transmit a cryptographic-key acquisition request including the external-device identifier to the server;
a receiver configured to receive the cryptographic key from the server, the cryptographic key being associated with the external-device identifier included in the cryptographic-key acquisition request;
a writer configured to write the cryptographic key received from the server to the storage area;
a reader configured to read the cryptographic key from the storage area; and
a data processor configured to process the copyrighted data using the cryptographic key read from the storage area.

2. The cryptographic-key management system according to claim 1, wherein
the server includes:
a cryptographic-key transmitter configured to transmit the cryptographic key to the terminal, the cryptographic key being associated with the external-device identifier included in the cryptographic-key acquisition request; and
a manager configured to manage whether or not the cryptographic key has been transmitted to the terminal,
if the cryptographic-key transmitter has not transmitted the cryptographic key yet by the time of receiving the cryptographic-key acquisition request, the cryptographic-key transmitter transmits the cryptographic key associated with the external-device identifier to the terminal, and
if the cryptographic-key transmitter has already transmitted the cryptographic key by the time of receiving the cryptographic-key acquisition request, the cryptographic-key transmitter cancels transmitting the cryptographic key associated with the external-device identifier.

3. The cryptographic-key management system according to claim 1, wherein
the terminal further includes a controller to determine whether or not the cryptographic key is stored in the storage area provided in the external device before the transmission of the cryptographic-key acquisition request, and
if the cryptographic key is not stored in the storage area, the acquisition-request transmitter transmits the cryptographic-key acquisition request.

4. The cryptographic-key management system according to claim 1, wherein
the cryptographic key is not stored in the storage area provided in the external device in the initial state, and the cryptographic key corresponding to the external-device identifier is written to the storage area by the terminal.

5. The cryptographic-key management system according to claim 1, wherein
the external device is capable of being disconnected from the terminal, and is capable of being connected to a different terminal that is different from the terminal, and
the different terminal reads the cryptographic key written to the storage area provided in the external device, and uses the read cryptographic key to process copyrighted data.

6. An external device that is connected to a terminal, the external device comprising:
a memory configured to store an external-device identifier that is an identifier of the external device, wherein
the memory includes a storage area to store a cryptographic key for copyrighted data, and
the cryptographic key is not stored in the storage area in the initial state, and the cryptographic key corresponding to the external-device identifier is written to the storage area by the terminal.

7. A cryptographic-key management program that manages a cryptographic key for copyrighted data by using a computer connected to an external device storing an external-device identifier that is an identifier for the external device,
the cryptographic-key management program causing the computer to execute the steps of:
transmitting a cryptographic-key acquisition request including the external-device identifier to a server;
receiving the cryptographic key from the server, the cryptographic key corresponding to the external-device identifier included in the cryptographic-key acquisition request; and
writing the cryptographic key received from the server to a storage area provided in the external device.

8. The cryptographic-key management program according to claim 7, causing the computer to further execute the steps of:
determining whether or not the cryptographic key is stored in the storage area provided in the external device, before the step of transmitting the cryptographic-key acquisition request; and
transmitting the cryptographic-key acquisition request if the cryptographic key is not stored in the storage area.
